(19) United States
(12) Patent Application Publication
(10) Pub. No.: US 2018/0165699 A1
(43) Pub. Date: Jun. 14, 2018

(54) SYSTEM AND METHOD FOR REPURCHASE INCENTIVES

(71) Applicant: INSIGHTS IGNITED LLC, Charlottesville, VA (US)

(72) Inventor: Sara Whiffen, Charlottesville, VA (US)

(73) Assignee: INSIGHTS IGNITED LLC, Charlottesville, VA (US)

(21) Appl. No.: 15/836,073

(22) Filed: Dec. 8, 2017

Related U.S. Application Data
(60) Provisional application No. 62/431,650, filed on Dec. 8, 2016.

(51) Int. Cl. G06Q 30/02; G06Q 10/08; G06Q 30/06

(52) U.S. Cl. CPC G06Q 30/0208; G06Q 30/0201; G06Q 30/0601; G06Q 10/0837; G06Q 30/0224

(57) ABSTRACT

Systems and methods for tracking customer purchases and providing repurchase incentives when a customer returns a purchased item outside of the limits of a standard and customary return policy are disclosed. The platform matches multiple individuals with multiple merchants, while facilitating, aggregating, and tracking buy and return transactions. It may also assume the risk for disposing of the used returned items from the merchant. It drives traffic back to merchants, promotes customer loyalty, and removes the need for customers and/or merchants to interface with the secondary market directly, but customers and/or merchants are still able to receive something of value for the returned item.

### RELATED APPLICATION

This application claims the benefit of U.S. Provisional Application No. 62/431,650, filed Dec. 8, 2016, and incorporated by reference in its entirety.

### FIELD

The present approach relates to retail transactions in goods, and more particularly to systems and methods for facilitating the return of goods to a merchant in exchange for one or more repurchase incentives at the merchant's establishment, over and above the customary return policy of a merchant (e.g., after the goods have been used by the purchaser).

### BACKGROUND

Contemporary retail commerce does little to reengage a customer after a purchase, and merchant outreach to customers has limited effectiveness at bringing customers back to the merchant. This is especially true of clothing retailers. Overall, retail merchants are facing excess inventory and reduced consumer demand. The supply and demand factors are also impacted by modern consumer trends, which are moving towards reducing the amount of goods one accumulates. While the desire to accumulate is generally diminishing, the desire to shop as an experience and to participate in trends remains. Retail location traffic is on a decline, but at a slower rate than the drop in retail sales from brick and mortar locations. The boom of internet shopping is certainly a factor. Thus, there exists a need to incentivize customers to shop and buy at retail locations.

As a general rule, returning items is discouraged as a practice by most retailers. While many popular retailers have return policies, those policies serve to reduce the frequency customers are returning items. Most retailer return policies operate as a disincentive to return to the same retailer. Current “standard” or customary merchant return policies generally limit the amount of time during which a purchased item can be returned. For example, most return policies are limited to 30 days or less. And as a further impediment, most return policies require that the purchased item be unused for the customer can receive a full refund. This policy also makes it easier for the merchant to restock the item. Returning a used item is rare, and many merchants do not accept used items on return. For merchants that accept returns of used items, the typical policy is to permit the return only if the item is highly unsatisfactory.

Some retailers have recently started to accept used clothing from customers in exchange for a repurchase incentive. Yet if a customer wants to get something valuable in return for something purchased from a merchant, the contemporary approach is to sell the used item via a consignment store or dispose of it through other secondary sources, such as a charitable donation. This procedure is inconvenient and time consuming for the customer, and detached from the original retail experience for the merchant.

As can be seen, there exists a need to intelligently incentivize customers to shop and buy at retail locations, and to find value in used merchandise. There is a need for a system and method that algorithmically or otherwise intelligently develops return incentives for used merchandize, such as through drawing from a customer's purchase transaction history specific items for which to offer a brand, and/or merchant repurchase credit, and/or subsequently tracks the redemption of the offer, and/or the disposition of the item thereafter.

### BRIEF DESCRIPTION OF THE DRAWINGS

FIG. 1 shows a demonstrative incentive communication according to an embodiment of the present approach.

FIG. 2 shows a representative flowchart for a system and method of providing repurchase incentives according to another embodiment of the present approach.

FIG. 3 shows a representative flowchart for a system and method of providing repurchase incentives according to another embodiment of the present approach.

FIG. 4 shows a representative flowchart for a system and method of providing repurchase incentives according to another embodiment of the present approach.

FIG. 5 shows a representative flowchart for a system and method of providing repurchase incentives according to another embodiment of the present approach.

FIG. 6 shows a representative flowchart for a system and method of providing repurchase incentives according to another embodiment of the present approach.

FIG. 7 shows a representative flowchart for a system and method of providing repurchase incentives according to another embodiment of the present approach.

FIG. 8 shows a representative flowchart for a system and method of providing repurchase incentives according to another embodiment of the present approach.

FIG. 9 illustrates an incentive communication generation and distribution platform according to an embodiment of the present approach.

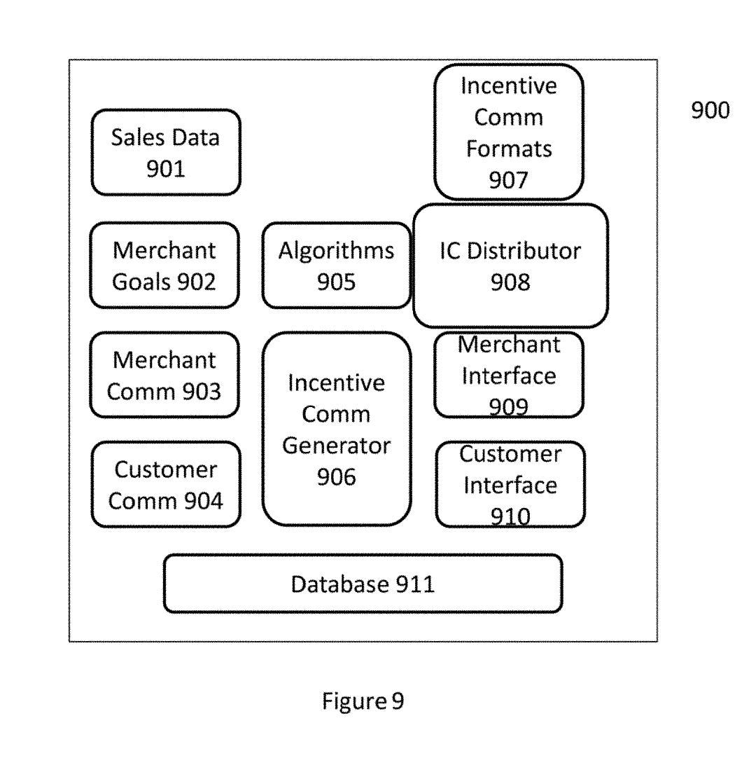

### DETAILED DESCRIPTION

The following description is of the best currently contemplated modes of carrying out exemplary embodiments of the present approach. The description is not to be taken in a limiting sense, but is made merely for the purpose of illustrating the general principles of the present approach, since the scope of the approach is best defined by the appended claims. It should be appreciated that those of ordinary skill in the art may practice the present approach through embodiments not explicitly described herein.

Customer purchase data and merchant sales data is an untapped resource for developing buy-back offers and other forms of incentives. As stated above, merchants are facing excess inventory and reduced consumer demand. Consumer trends are moving towards reducing the amount of goods one accumulates. While the desire to accumulate is diminishing, the desire to shop as an experience and to participate in trends remains. The present approach bridges these challenges with solutions that reconnect merchant and customer through mutually beneficial, intelligent incentive communications. The present approach also enables merchants to look at market share as an effort to “own the hanger”—as one item is removed from a customer's hanger, another item from the same merchant, as opposed to a competitor, replaces it.

Embodiments of the present approach provide systems and methods that allow merchants to incentivize customers who purchased items from the merchant, to return an item to the merchant and receive an incentive from the merchant. The merchant may have a secondary market for the returned item, such that the incentive offered makes a good business case. Similarly, the incentive may be sufficient to entice the customer to make new purchases at an amount profitable to the merchant. It may also be the case that the customer is not using the item, and will find value in returning the item in exchange for the incentive offer. For example, a merchant may use the present approach to identify a top-selling pair of boots from several seasons ago, and offer customers who purchased those boots an incentive to return the boots in exchange for store credit. Customers who purchased the boots may no longer wear them, or may find enough value in the offer, making it beneficial to return the boots and accept the incentive offer. In some embodiments, the level of credit may vary depending on the quality of the item. Also, the returned item may have value through another channel the merchant has available (e.g., re-sale, donation, etc.).

In some embodiments, individuals who have purchased items at a participating merchant may opt into a program enabling them to receive incentive communications offering the return specific items or goods in exchange for a specific value, such as store credit. The incentive communication may be distributed by the merchant in some embodiments, or through a third-party service in other embodiments. For example, merchants and/or brands may opt to participate in the incentive communication program in some embodiments, and in other embodiments the incentive program may be licensed and/or transacted independently (e.g. by a third party). For example, in one embodiment a clothing retailer may employ an incentive communication program specific to, or limited to, that particular retailer. Customers of that retailer also participating would receive incentive communications from that retailer (or a third-party on that retailer's behalf). In other embodiments, several retailers may participate in the same incentive communication program. In such embodiments, a third-party service—such as an app, electronic mail service, social media presence, etc.—may distribute incentive communications for participating retailers. Alternatively, retailers may distribute their own incentive communications through the same third-party service.

In some embodiments, the disposition of returned goods received in response to an incentive communication program may be tracked and managed. For example, returned items may be catalogued and identified for donation, re-sale, shipment to another location, etc. Some embodiments may incorporate a comprehensive inventory management component. Data that may be collected include, but are not limited to, item description, brand, condition upon receipt, date returned, method returned, location where returned, amount of store credit issued, date store credit issued, any restrictions on store credit, where the item is placed for disposition, etc. It should be appreciated that a person of ordinary skill in the art can determine what data would be appropriate for a specific embodiment. Such data may be used to facilitate the operations and disposition of returned items, as well as provide useful insight into item lifetime, item value retention, customer usage habits, and effectiveness of this program, among numerous other potential metrics.

Embodiments of the present approach may also enable a third party to collect returned items from the merchant, and to dispose of them via resale transactions in a secondary market, charitable contribution, or permanent disposal. If the returned item is directed to a secondary market, then disposition can include resale through either or both a brick and mortar location, or an online platform. Returned items subject to resale may be sold through an existing merchant or third-party channel, though some embodiments of the present approach may support its own online sales channel. Some embodiments of the present approach may include an online platform for disposition of returned items, such as through straightforward sales to online auctions.

Some embodiments may involve returned items disposed through charitable donation. It the item is directed towards a charity, it could be issued as a donation, possibly as a tax deductible action. Some embodiments may track donated items and value, and supply data to support tax-related documentation. Some embodiments of the present approach may be configured to identify which option for returned item disposal presents the best option based on various parameters, such as, for example, location where the item is currently stored, shipping/mailing costs, resale value, marketing segmentation, etc.

Some embodiments of the present approach may take the form of a system. Embodiments of an incentive communication development and distribution system may include a merchant system. The merchant's system may contain historical sales data from which incentive communications may be generated. The merchant's data may include, for example, prior sales transactions for the merchant's items, including item identification, item purchase price, total transaction value, transaction date, and a customer identifier, such as a name, loyalty/rewards account, customer email, and the like. This information may be received by an incentive generation system or platform. The incentive generation system may take the form of a computer system, operating on a server or other electronic device, configured to receive and disseminate date. It should be appreciated that the present approach is not intended to be limited to the type of electronic device.

In some embodiments, the merchant may also provide a goal to direct the incentive generation. For example, a merchant goal may be to incentivize return of an item that sold strongly in past seasons, but dropped off (e.g., no longer in fashion). As another example, a merchant goal may be to identify customers that spent more than a threshold amount at the merchant by a certain date, but haven't spent anything at the merchant after that date. As another example, a merchant goal might reflect how a merchant identified a valuable secondary market for an item, and have an interest in encouraging the return of the item. For example, a merchant may partner with another entity having similar objectives, to support the return of a customer's item in the interest of stimulating repurchase at that merchant, for example a fitness center and a clothing store. The store could advertise that items purchased there are eligible for wear and return and that customers who buy from that store would be eligible to receive buyback offers from the merchant. In an example embodiment, a customer could buy an item, lose weight, and return the item for something in a smaller size. It should be appreciated that such embodiments are applicable to customers who are pregnant and experience weight gain during and loss afterwards, as well.

Another example—a store could offer a button on their website saying “make me an offer” where the customer would identify that they are open to receiving an offer for an item they have purchased from that store in the past. As another example, a merchant goal may be to increase the sale of a new item, through returning the same type of item sold in prior years. As yet another example, a merchant goal may be to compete with another merchant's sale by offering incentives on specific items. It should be appreciated that an incredibly wide range of merchant goals may be applicable, depending on the merchant and the particular embodiment. For example, a merchant might want to encourage a customer to take a chance on a particularly trendy, fashionable, or more expensive item by advising the customer of the option to return it after use.

The incentive generation platform may be configured to analyze the merchant's historical sales data may and, if provided, merchant goal(s), to generate incentive communications. It should be apparent that the content of the data and, if present, merchant goal(s), should be sufficient to identify customers to receive the incentive communication, and item(s) subject to the incentive communication. The incentive generation platform can apply algorithms to identify potential incentives, such as incentives likely to further the merchant's goal(s). For example, if the merchant goal is to identify customers that spent more than a threshold amount at the merchant by a certain date, but haven't spent anything at the merchant after that date, then the incentive generation platform can extract the customers from the historical sales data that meet or exceed the threshold spending amount prior to the certain date. The incentive generation platform could then identify one or more items subject to the past transactions for this customer subset, and generate incentive communications based on those items. For example, if each customer in the subset purchased the same jacket, then a single incentive communication may be generated for distribution to each of these customers. Alternatively, multiple incentive communications may be generated for this subset, such as if these customers had dissimilar purchases, or if there are limited common items for the transactions involving these customers.

Once the item(s) subject to the incentive communication are determined, the incentive generation platform may then determine the incentive offer itself. It should be appreciated that the incentive offer may be as simple as a flat rate store credit, or as complicated as desired based on the particular embodiment. For example, if the item subject to the incentive communication has a significant secondary market, then the incentive could be determined such that sale at the secondary market remains profitable. If a jacket's value in a secondary market is $100, for instance, the cost of handling is $25, and the merchant's target profit is $25 per returned item, then the incentive generation platform may calculate an incentive value of $50. As another example, the incentive communication generator may be configured to calculate an incentive value likely to encourage a customer to return and spend more than a certain amount at the merchant. For example, if the merchant offers a jacket for $100, and a competitor offers a similar jacket for $85, then the incentive communication generator may calculate an incentive value of more than $15 to encourage the customer to buy from the merchant as opposed to the competitor. The algorithm could include a customer value calculation, an item's wholesale price, retail price, purchase price, gross margin, season in which purchased, season in which used, resale value, etc. As yet another example, the incentive generation system may be configured to determine an incentive value based on the anticipated donation value of an item. Those of ordinary skill in the art will appreciate that there are numerous potential algorithms that may be used by an incentive generation system to generate an incentive communication, and that the present approach is not intended to be limited to any particular algorithm.

Once the item(s) subject to the incentive communication and the incentive itself are determined, embodiments of the incentive generation system may generate one or more incentive communications. An incentive communication may be any form of communication to a customer in the subset, identifying the item(s) subject to the incentive communication, and the incentive offer. For example, the incentive communication may take the form of an email communication, an app notification, a social media message, among other forms. The incentive communication may include an image of the item(s) and associated incentives.

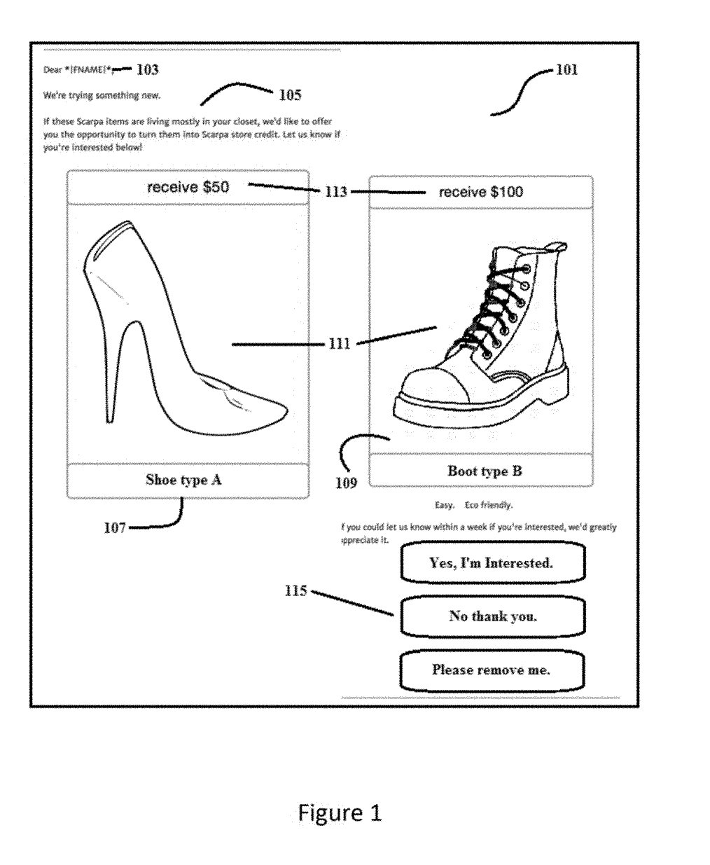

FIG. 1 is an example of an incentive communication 101. The communication is configured for distribution as an email communication, and includes one or more fields 103 for auto-population based on the merchant's historical sales data, such as a customer name and email address. This embodiment includes a brief message 105 to the customer providing context, and incentives 107 and 109. Both incentives 107 and 109 include images 111 of an item, and an incentive offer 113 for merchant credit. This embodiment also includes immediate electronic feedback options 115, which are configured to allow a customer to indicate interest in an incentive, or other alternatives. In some embodiments, the incentive communication links the returnable item and the incentive amount to increase the chance of a customer immediately understanding the offer.

In some embodiments in which a third party provides the incentive communication platform, the system may reallocate the risk for disposing of the used returned items from the merchant to the third party. Alternatively, embodiments of the present approach may be used by the merchant to facilitate restocking/resale of the previously used item.

Systems and methods of the present approach may advantageously drive customer traffic back to merchants, promote customer loyalty, and remove the need for either customers or merchants to interface with the secondary market directly, with both customers and merchants still receiving something of value for their used item. Embodiments of the system may engage a plurality of customers with a plurality of merchants, while facilitating, aggregating, and tracking buy and return transactions. Embodiments also may generate items that can command value in the resale/secondary/consignment marketplace.

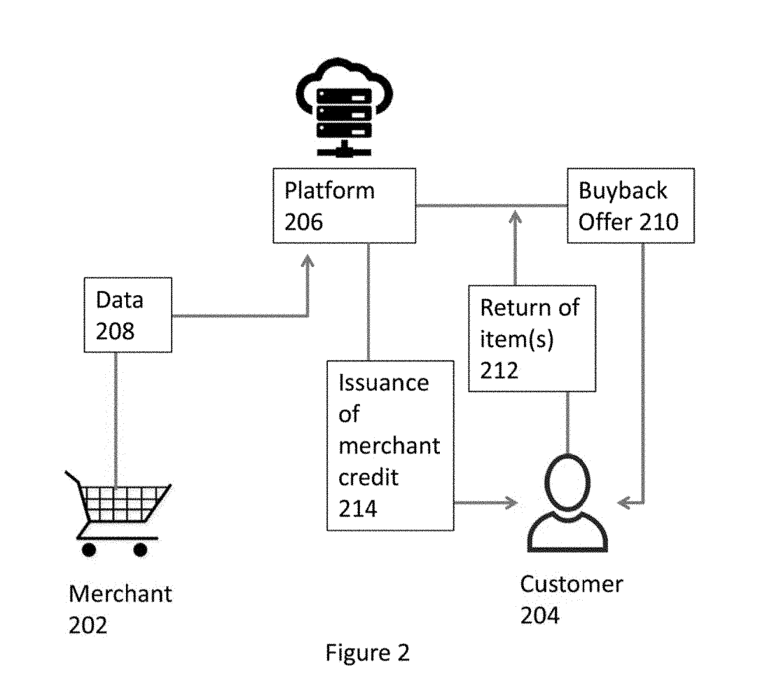

A representative system and method for implementing and embodiment of the approach are shown in reference to FIG. 2. As shown in this embodiment, the present approach allows customer 204 to exercise an option to return an item that has been purchased from merchant 202 and used. Platform 206 receives historical sales data 108, in this case from merchant 202. This data may include, for example but not limited to, transaction data (such as purchase date, price, item description, size, color, brand, store where purchased, method of purchase, discount, promotion applied, etc.), behavioral data (such as customer's previous buying behavior, previous interactions with that store or others, previous interactions with the brand being purchased or others, etc.), demographic data (age, birthday, gender, address, etc.) and/or lifestyle data (i.e. social media interactions, activity preferences, hobbies, etc.). The merchant may select what data to provide, or the platform may determine what data is necessary. Data 208 may also include one or more merchant goals, which may be used by incentive generation platform 206 to generate an incentive communication, such as buyback offer 210.

Platform 206 generates a buyback offer 210 that identifies one or more customers 204 to receive the incentive communication, includes one or more items subject to the incentive communication, and an incentive offer, such as store credit. Embodiments may use various algorithms to determine the incentive communication, as discussed herein. In this embodiment, platform 206 transmits the buyback offer 210 to customer 204. This offer may be transmitted electronically, telephonically, or through tangible mediums such as postal mail. The buyback offer 210 may be comprised of terms under which the customer's previously purchased items can be returned in exchange for store credit or another merchant incentive, such as upon receipt of the item. The buyback offer 210 may specify conditions, such as usage or wear and tear on the item, requisite before receiving the incentive.

Customer 204 may accept, decline, or ignore the buyback offer 210. If the customer accepts the offer, some embodiments may include notification, either electronically within the offer, electronically outside of the offer, or through other communications means. Customer's response may identified as affirmative, in which case some embodiments may provide the customer 204 instructions with how to return 212 the item(s) identified by the buyback offer. In this embodiment, item return 212 is shown as occurring in connection with platform 206. It should be appreciated that the physical return may occur at the merchant 202, or another third party.

In some embodiments, the incentive communication may include a promotional code or a similar code with a link to a website or app. The code may be used to obtain an additional incentive, provide and/or receive information relating to an incentive, an item, and/or other opportunities from the merchant. In some embodiments, the website or app may include a popup incentive offer, which the customer may accept or decline at that time. Some embodiments may also allow the customer to make a counterproposal, such as on the value of the incentive.

It should be appreciated that platform 206 may be configured to process the return of the item, matching the characteristics of the item returned with the characteristics of the buyback offer to ensure that the item matches that which was identified in the offer. Platform 106 may also record other characteristics of the item pursuant to the conditions of the incentive communication (e.g. condition of the item, timeframe of receipt, etc.).

Upon verification of item receipt and any other conditions, the platform 206 in this embodiment issues the corresponding store credit or other incentive to the customer 204. It should be appreciated that in other embodiments, the incentive may be awarded upon physical return of items to the merchant.

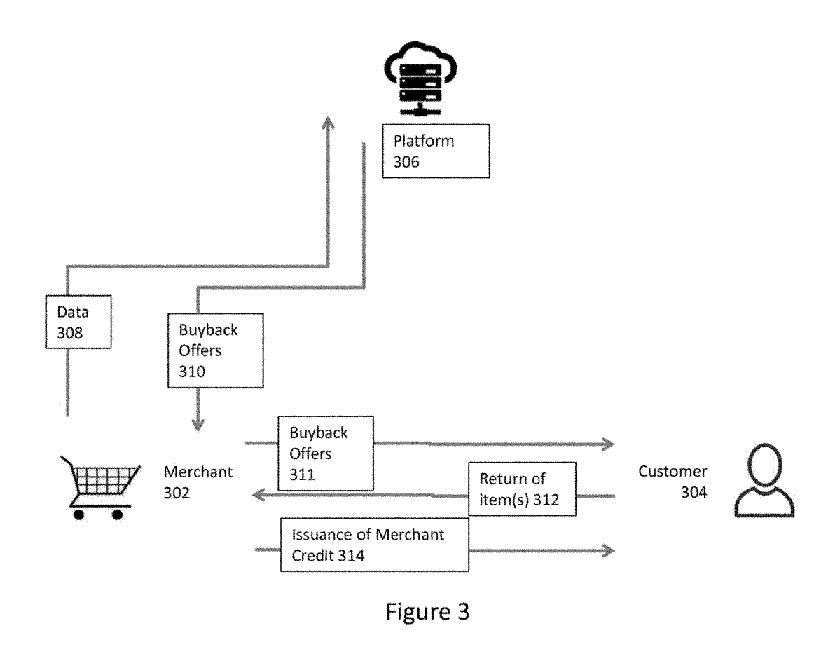

FIGS. 3-8 show different embodiments of the present approach to demonstrate the versatility of the present approach. Generally, these embodiments demonstrate the versatility of the present approach. In FIG. 3, merchant system 302 transmits historical sales data 308 to platform 306, and platform 306 returns buyback offers 310 to merchant 302. In this embodiment, merchant 302 then directly interacts with customer 304, through distributing the incentive communication 311 to customer 304, receiving returned items 312 from customer 304, and issuing merchant credit 314 (or other incentive).

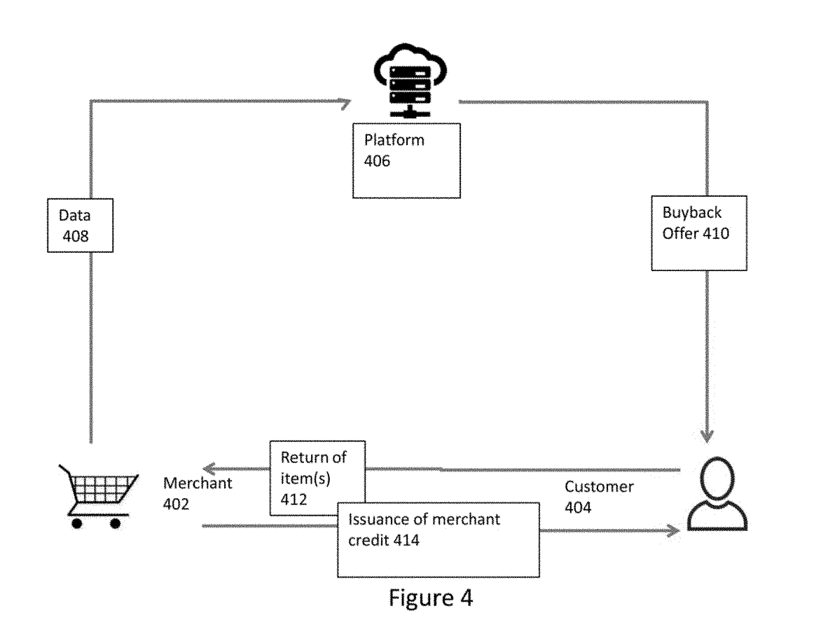

FIG. 4 shows an embodiment in which the platform 406 issues incentive communication 410 directly to customer 404. In this embodiment, customer 404 returns items directly to merchant 402, and merchant 402 issues the credit 414 (or other incentive) directly to customer 404.

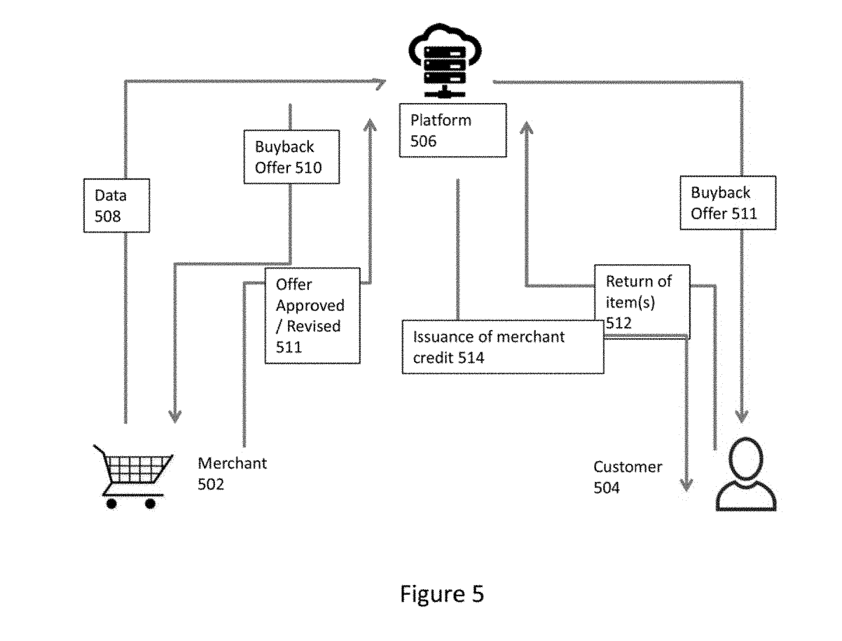

FIG. 5 shows an embodiment in which merchant 502 supplies historical sales data 508 to platform 506, and platform 506 runs algorithms to generate incentive communication 510. In this embodiment, incentive communication 510 is returned to merchant 502, for approval/revision 511 back to platform 506. Once approved, this embodiment shows platform 506 distributing incentive communication 511 to customer 504. In this particular embodiment, customer 504 returns items 512 to platform 506, and platform 506 then issues the incentive (e.g., merchant credit 514).

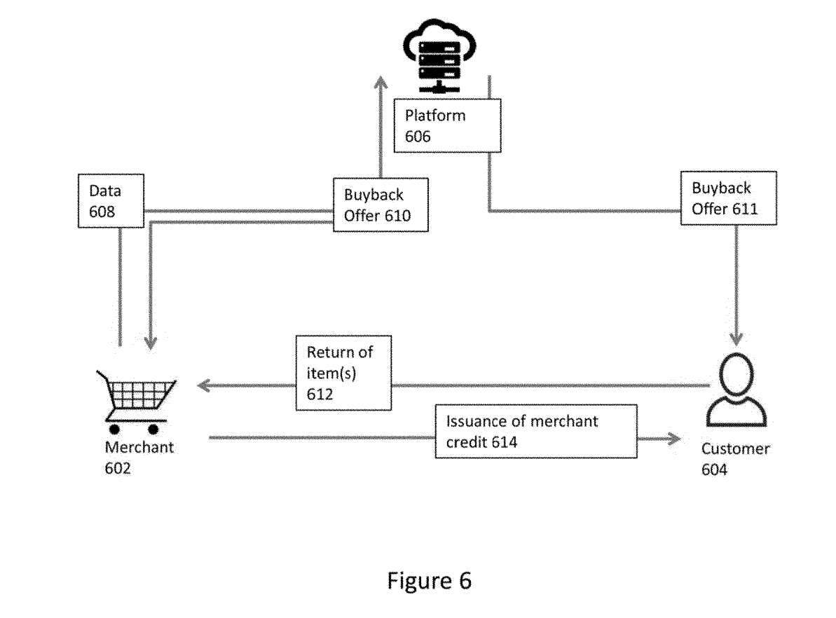

The embodiment shown in FIG. 6 shows an embodiment in which platform 606 receives historical sales data 608 from merchant 602, and sends proposed incentive communication 610 to merchant 602. If merchant does not revise or decline the proposed incentive communication within a certain time, or otherwise indicates approval, platform 606 distributes incentive communication 611 to customer 604. Customer 604, in this embodiment, returns items 612 directly to merchant 602, who in return issues incentive 614 to customer 604.

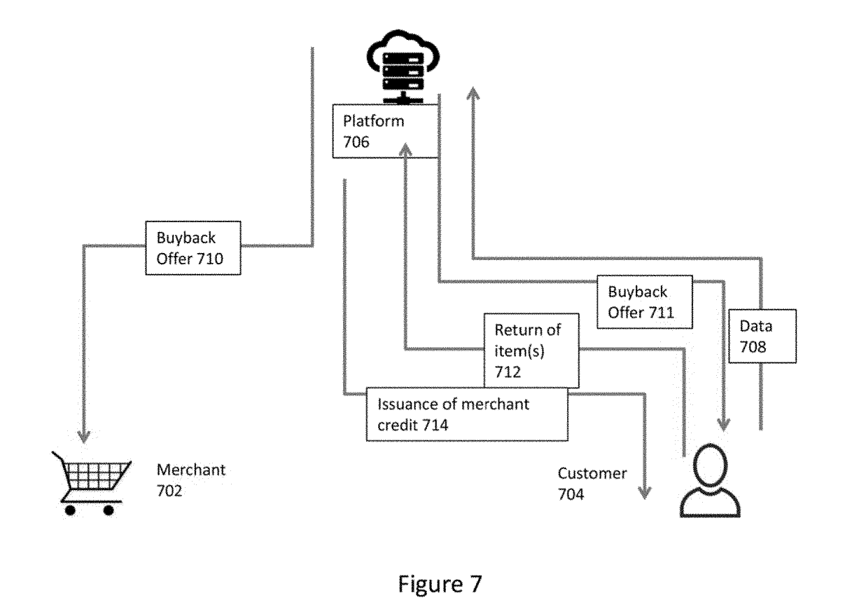

In some embodiments, customers may supply data to the incentive generation platform, which in turn issues incentive communications to merchants. Such embodiments may be particularly useful for items that retain value and/or usefulness for long periods of time, such as medical devices along the lines of wheel chairs and fitness products such as weight sets. These embodiments may also be useful in scenarios in which a customer is likely to undergo changes over time, such as weight loss after pregnancy or dieting. FIG. 7 shows an example in which customer 704 supplies customer data 708 to platform 706. Customer data may include, for example, customer identification, item identification, item status, item purchase data, customer details (e.g., weight, height, etc.), and the like. Platform 706 then issues proposed incentive communication(s) 710 to merchant 702. Once approved, platform 706 then distributes incentive communication 711 to customer 704, and facilitates item return 712 and incentive issuance 714. For example, customer 704 may have purchased clothing at a certain size prior to a new fitness and diet regimen. Following that regimen, customer may submit progress data to the platform 706. Once certain metrics are met, platform 706 may recommend incentive communications, and deliver them after merchant approval. The merchant and/or platform may develop such criteria, which may be in the form of merchant goals or other information provided to the platform.

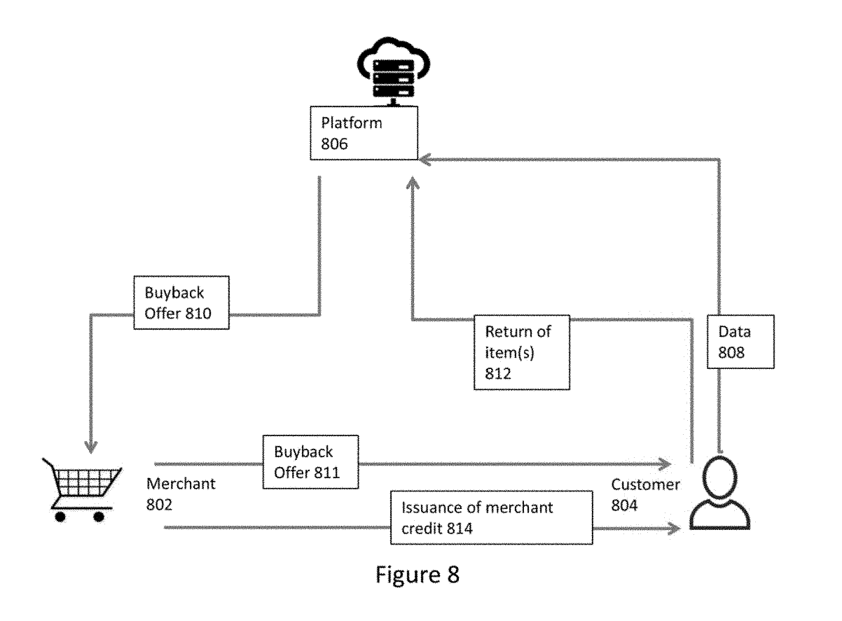

In the FIG. 8 embodiment, customer 804 provides customer data 808 to platform 806. Platform 806 then recommends incentive communications 810 to merchant 802, who may then distribute incentive communications to customer 804. Although it should be appreciated that item return and incentive issuance can occur through numerous other ways as disclosed herein, this embodiment shows customer 804 returning items 812 to platform 806, and receiving merchant credit 814 from merchant 802.

It should be appreciated that the platform may be operated by a third party, and service one or multiple merchants as disclosed herein. In the described embodiments, platform represents an electronic system and, in some instances, a physical presence (e.g., such as a location for returning items).

In some embodiments, the incentive generation platform uses merchant historical sales data to develop incentive offers to repurchase items from customers, typically items that these same customers have previously purchased from merchant retailers. The incentive generation platform may synthesize that data, which may include strategic and qualitative information to develop incentive communications matching previously purchased products to the customers who purchased those products, and providing them with a price or value for the receipt of those items in return. Customer acceptance, decline, or apathy for the offer may be tracked in some embodiments, including whether the customer returns the item to the directed address. Upon receipt of the item, the customer may be notified by the platform or other element that all the conditions have been met. Then the customer may be issued the credit pursuant to the terms of the offer.

Notably, for the attainment of the data required to initiate the buyback offers, the historical sales data can come from any number of sources: an individual merchant retailer, a group of retailers, a brand, a distributor, a franchise, an affiliate platform, a loyalty provider, an association, and/or an aggregate group of merchants. The data transfer itself may occur through known means, such as file transfer, a connection between the incentive generation platform and the point of sale system, secure data transfer pipelines, or other data transmission means. This data can also come directly from a customer or from a group of customers, depending on the embodiment. Historical sales data may include data attained at time of purchase and held for a period of time until the incentive communication is made, and/or pre-existing data.

As discussed above, generation of the incentive communication can be done in several ways. For example, the platform can manually develop offers based on retailer goals. As another example, the platform can algorithmically create offers based on retailer goals.

As another example, a merchant goal may be to increase the frequency of infrequent customers. The platform may then be configured to identify from the merchant's historical sales data three primary segments of purchasers based on visit frequency: 1-2 times over 24 months; 3-5 times over 24 months; and 6+times over 24 months. The platform then may generate an incentive communication for the subset of customers in the 1-2 times segment. The incentive offer may be customer-specific or seek common items, and promote an exchange of the item(s) for enough store credit encourage the customer to visit the merchant and make a purchase. The incentive may be date-specific, such as making the incentive available only for a certain amount of time, or on certain days. The platform may also generate additional incentive communications for customer subsets in the other segments, perhaps rewarding frequency, incorporating customer loyalty, and so on. It should be appreciate that there are a wide range of potential incentive structures, and that this disclosure is not intended to be limited to only those exemplar incentives disclosed herein.

Using the previous hypothetical, a sample method may be described. First, the incentive generation platform identifies one or more customers that fits that the target criteria (e.g., 1-2 merchant visits over the past 24 months). Next, the platform identifies an item that that customer purchased that would qualify for a buyback (such as items of a particular brand, price point, for this merchant they wanted to offer buybacks only on items that had been purchased at full price, type of item—season in which the offer is made influences this, resale value, etc.). The platform then generates a “buyback price” or other incentive value based on the merchant's data and/or other input. In some embodiments, merchant approval may be required before the platform distributes the incentive communication(s). In some embodiments, the merchant distributes the incentive communication(s).

In this example, the platform generated emails for the incentive communications, and delivered them to the customer. The incentive communications may include the merchant's branding and/or conform with the merchant's style guide. The customer accepted the offer through clicking a link embedded in the email, after which a third party took possession of the returned item and confirmed with the merchant that the returned item was in possession. Some embodiments may also require confirmation that the returned item meets condition requirements. Upon confirmation, the merchant may issue a store credit on their end, and provide confirmatory communication to the platform that the credit has been issued. In such embodiments, the platform may send a notice to the customer that the credit has been issued. The customer may then visit the merchant and take advantage of the store credit.

The incentive communication generation platform may include an interactive user interface that either directly connects with the merchant system, such as a merchant point of sale system, or indirectly connects with the merchant through an app or software interface. The connectivity allows the merchant to input information and data that may serve as inputs for the incentive communication generation process, whether manual or algorithmically derived. The connectivity may also permit the merchant to approve and/or modify incentive communications in some embodiments.

The incentive may be a buyback offer that may be presented to the customer as a total dollar amount in store credit, percentage, points, or other relevant merchant or accepted currency. Some embodiments may incorporate a merchant's customer loyalty program, and make contributions to such a program.

There are numerous ways of handling and disposing of returned items. For example, the returned items can be delivered either to the merchant directly, to the platform, or to another partner assisting in the processing and resale of the item(s). The entity that receives the item may communicate certain information with the platform, such as date, condition of the item, etc.

With respect to the incentive, the offer may be fulfilled and credit issued to the customer either via the platform itself, the merchant, or other entities partnering with the platform. It should be appreciated that this may vary in different embodiments. After fulfillment, the platform may be configured to continue to receive transaction data so as to track the effectiveness of the process, etc. This information could then be used to assess satisfaction with the item, perceived customer value, future purchasing requirements, styling preferences, etc.

It should be appreciated that some embodiments may feature a central incentive communication generation platform, used by multiple merchants and customers. The incentive communication distribution system may be incorporated into the platform, though it may be separate in some embodiments. Individuals and merchants can be added to the system in any order. The system may be extended to include the return of previously used goods acquired as new to the individual (e.g., from consignment stores and other used goods resellers).

As contemplated by present approach, individuals can purchase items, use them, and they have the option to return them to the store of purchase, contingent on any conditions, if any, of the offer extended, and in return receive an incentive to repurchase item(s). The merchant gets additional foot traffic, loyalty, increased purchases from the customer, and additional customer data.

The present approach may be implemented for a variety of goods. For example, the present approach may be adopted to manage the recycling of medical equipment (such as braces, wheelchairs, crutches, etc.) among users who only have temporary needs for these products. It can be used for many types of merchants, including, but not limited to: bookstores, clothing stores, shoe stores, accessory stores, jewelry stores, maternity stores, baby stores, toy stores, sporting equipment, home goods, etc. It may allow customers and merchants to gain the benefits of participating in the consignment/used resale market without actually having to transact in that market. This platform generates a new type of transaction between merchants and customers and generates items that can command value in the resale/secondary/consignment marketplace. In some embodiments, customers may upload customer data including purchasing requirements (e.g., items of interest, purchasing budget, other constraints, etc.), and then the platform may generate incentive communications to distribute to one or more merchants.

FIG. 10 shows an embodiment of an incentive communication generation and distribution platform according to an embodiment of the present approach. This platform may take the form of an electronic platform 900, operated by a merchant or third party. Platform 900 may be distributed across multiple electronic devices, or reside on a single computer system as a standalone program or app. Platform 900 includes merchant sales data (and/or customer data) 901 as described above. For embodiments involving merchant goals, platform 900 includes merchant goals 902 received from one or more merchants, including either or both pre-existing goals and recently-received goals. Platform 900 in this embodiment includes merchant and customer communication pathways 903 and 904, which may be any form of data transmission to send and receive data to and from platform 900. Merchant communication pathway 903 may also be configured to transmit proposed incentive communications and item return confirmations to a merchant. In some embodiments, platform 900 may be configured to track items, including status, location, value, disposition, and the like. Some embodiments may include merchant and customer interfaces 909 and 910, which may be configured to allow merchants and/or customers to interact with the platform 900. The type of interaction depends on the embodiment, but it should be appreciated by those of ordinary skill in the art that some embodiments may benefit from allowing merchants and/or customers to interact directly with the platform 900, such as for providing information, responding to messages, accepting or declining incentive offers, and the like. Database 911 may include all or a portion of the data stored by platform 900, and may take the form of one or more databases.

Platform 900 also includes one or more algorithms 905 and an incentive communication generator 906. As described above, the number and type(s) of algorithms will depend on the particular embodiment. The incentive communication generator 906 may be configured to generate communications as desired for a particular embodiment. Some embodiments of platform 900 will include one or more communication formats 907. For example, a merchant may desire for incentive communications to appear on the merchant's letterhead or with the merchant's branding. Communication formats 907 may be populated with such formats. Some embodiments may include an incentive communication distributor 908, configured to send incentive communications as needed for the particular embodiment. For example, distributor 908 may take the form of an email delivery system, an app notice system, or other distribution systems that deliver incentive communications to the target recipient(s).

The system of the present approach may include at least one computer with a user interface, an algorithm, and/or an application. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present approach may also be implemented in software stored on a non-transitory computer-readable medium and executed as a computer program on a general purpose or special purpose computer. For clarity, only those aspects of the system germane to the approach are described, and product details well known in the art are omitted. For the same reason, the computer hardware is not described in further detail. It should thus be understood that the approach is not limited to any specific computer language, program, or computer. It is further contemplated that the present approach may be run on a stand-alone computer system, or may be run from a server computer system that can be accessed by a plurality of client computer systems interconnected over an intranet network, or that is accessible to clients over the Internet. In addition, many embodiments of the present approach have application to a wide range of industries. To the extent the present application discloses a system, the method implemented by that system, as well as software stored on a computer-readable medium and executed as a computer program to perform the method on a general purpose or special purpose computer, are within the scope of the present approach. Further, to the extent the present application discloses a method, a system of apparatuses configured to implement the method are within the scope of the present approach.

It should be understood, of course, that the foregoing relates to exemplary embodiments of the approach and that modifications may be made without departing from the spirit and scope of the approach as set forth in the following claims.

What is claimed is:

1. An incentive communication development and distribution system comprising:
a merchant system having historical sales data relating to at least one of a plurality of items and a plurality of customers;
an incentive generation platform configured to receive the at least one of a plurality of items and a plurality of customers, and at least one merchant goal, from the merchant system, and to generate an incentive communication to at least a subset of the plurality of customers for at least one of the items based on at least the historical sales data and the at least one merchant goal; and
an incentive communication distribution system configured to receive the incentive communication from the incentive generation platform and distribute the incentive communication to the at least a subset of the plurality of customers;
wherein the incentive communication contains an offer to return the at least one of the items to a merchant in exchange for a purchasing incentive at the merchant.

2. The system of claim 1, wherein the merchant goal comprises a specific item and a return value for the specific item, and the incentive communication contains an offer to return the specific item for a merchant location credit of lesser value than the return value.

3. The system of claim 1, wherein the merchant goal comprises a specific sales date, and the incentive communication contains an offer to return a first category of items sold prior to the specific sales date.

4. The system of claim 1, wherein the incentive generation platform is configured to identify a second category of items from the plurality of items, the second category of items defined by at least one of the number of sales of the second category of items in the historical data and the frequency of sales of the second category of items in the historical data, and the incentive communication comprises an offer to return the second category of items.

5. The system of claim 1, wherein the incentive communication comprises an image of the at least one of the items.

6. The system of claim 1, wherein the incentive communication comprises one of an electronic mail, a social media contact, and an app notice.

7. The system of claim 1, wherein the incentive communication further comprises a response request including a first option for indicating interest in the offer and a second option for indicating disinterest in the offer.

8. An incentive communication development and distribution platform comprising:
a database comprising an algorithm for generating an incentive communication from merchant historical sales data and a merchant goal;
a merchant goals database for receiving and storing a merchant goal;
a merchant historical sales data database for receiving and storing merchant historical sales data;
an incentive communication generator configured to generate an incentive communication based on the algorithm, at least one merchant goal, and at least a portion of merchant historical sales data received from a merchant;
a merchant communication module configured to receive merchant historical sales data from a merchant, the merchant historical sales data having data relating to at least one of a plurality of items and a plurality of customers;
wherein the incentive communication generator is configured to generate an incentive communication containing an offer to return the at least one item in exchange for a purchasing incentive at the merchant.

9. The incentive communication development and distribution platform of claim 8, further comprising an incentive communication distribution module configured to distribute the incentive communication to at least one of a merchant and a customer.

10. The incentive communication development and distribution platform of claim 8, further comprising a merchant interface configured to permit a merchant to at least one of review, modify, approve, and distribute an incentive communication generated by the platform.

11. The incentive communication development and distribution platform of claim 8, further comprising a customer interface configured to permit a customer to at least one of receive an incentive communication, respond to an incentive communication, and upload customer data.

12. The incentive communication development and distribution platform of claim 11, wherein the customer data contains data relating to at least one customer item, and the incentive communication generator is configured to generate an incentive communication relating to the at least one customer item.

13. The incentive communication development and distribution platform of claim 8, wherein the incentive communication comprises at least one of an electronic mail, a social media contact, and an app notice.

14. A method of generating and distributing incentive communications, the method comprising:
receiving merchant historical sales data relating to at least one of a plurality of items and a plurality of merchant customers;
receiving at least one merchant goal;
generate an incentive communication to at least a subset of the plurality of customers for at least one of the items based on at least the historical sales data and the at least one merchant goal;
distributing the incentive communication to at least one of a merchant and the at least a subset of the plurality of customers;
wherein the incentive communication contains an offer to return the at least one of the items in exchange for a purchasing incentive at the merchant.

15. The method of claim 14, wherein the incentive communication comprises at least one of an electronic mail, a social media contact, and an app notice.

16. The method of claim 14, wherein the incentive communication is distributed to the merchant, and further comprising a merchant distributing the incentive communication to at least a subset of the plurality of customers.

17. The method of claim 14, wherein the incentive communication is distributed to the merchant, and further comprising receiving at least one of an incentive communication approval and an incentive communication revision from the merchant.

18. The method of claim 13, further comprising receiving a returned item from a returning customer, and issuing an incentive to the returning customer.

19. The method of claim 14, wherein the returned item is received at the merchant, and the incentive is issued by the merchant.

20. The method of claim 13, further comprising issuing a confirmation message to the merchant to confirm receipt of a returned item, and issuing the incentive in response to the confirmation message.
